(19) United States
(12) Patent Application Publication
(10) Pub. No.: US 2020/0311156 A1
(43) Pub. Date: Oct. 1, 2020

(54) SEARCH-BASED URL-INFERENCE MODEL

(71) Applicant: Microsoft Technology Licensing, LLC, Redmond, WA (US)

(72) Inventors: Junzhe Miao, Redmond, WA (US); Yunpeng Xu, Millburn, NJ (US); Wenxuan Gao, Santa Clara, CA (US)

(21) Appl. No.: 16/370,642

(22) Filed: Mar. 29, 2019

(51) Int. Cl. G06F 16/955; G06F 16/953; G06N 20/00; G06K 9/62

(52) U.S. Cl. CPC G06F 16/955; G06K 9/6218; G06N 20/00; G06F 16/953

(57) ABSTRACT

Techniques of inferring an organic website URL of an organization based on a web search result are provided. A query that includes an organization name is sent to a search engine and a set of search results is received from the search engine as a result of the query. Each search result in the set of search results includes a URL for the organization website address. For each search result in the set of search results, a set of feature values that is associated with each search result is identified. The set of feature values is inputted to a prediction model that generates a prediction, and based on the prediction, a determination of whether to associate the URL of each search result with the organization name is made.

### TECHNICAL FIELD

The present disclosure relates to determining an organic website of an organization and, more particularly, to inferring an organic website Uniform Resource Locator (URL) of an organization based on a web search result.

### BACKGROUND

Content delivery systems that publish electronic content related to organizations may include a database that stores organization information, such as an address, a phone number, an industry, a size, and a product or service. Such information about the organization can be easily collected from an organization's official website. In such a modern world, inferring organization information without relying on the official website of the organization may become tremendously difficult. However, as the database includes millions of records for organizations, the database may not include organic website URLs for certain organizations. Without access to those website URLs, a content delivery system's utility suffers. For example, the content delivery system will not be able to provide value to organizations for which website URLs are lacking and will not be able to provide relevant information about those organizations to end users of the content delivery system.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example URL inference pipeline for inferring an organic website URL of an organization, in an embodiment;

FIG. 2 is a flow diagram that depicts a process for inferring an organic website URL of an organization based on a web search result, in an embodiment;

FIG. 3 is an example user interface of the web search result, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques of inferring organic website URLs of organizations based on web search results are provided. A query that includes an organization name is sent to a search engine and a set of search results is received from the search engine as a result of the query. Each search result in the set of search results includes a URL. For each search result in the set of search results, a set of feature values that is associated with that search result is identified. The set of feature values becomes input to a prediction model that generates a prediction, and based on the prediction, a determination of whether to associate the URL of each search result with the organization name is made.

Embodiments described herein improve the utility of electronic content delivery methods by inferring a URL for an organic organization website using the search-based URL inference model. Embodiments improve the completeness and accuracy of content data by determining an organic website URL for the organization, collecting relevant information about the organization, and verifying and validating the organization information.

### System Overview

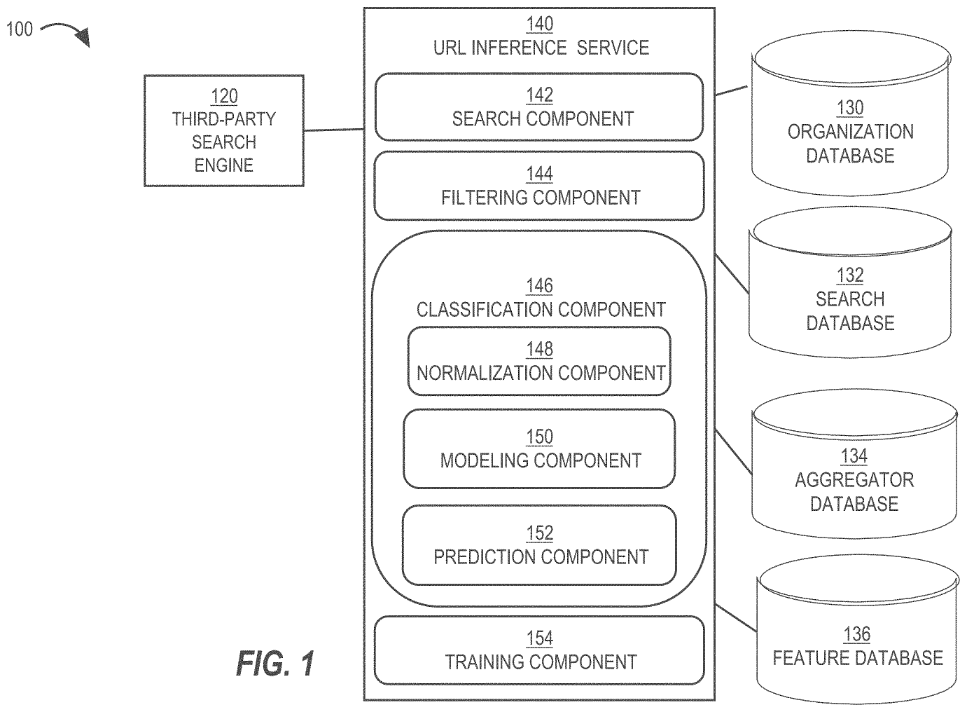

FIG. 1 is a block diagram that depicts an example URL inference pipeline for inferring an organic website URL of an organization, in an embodiment. A URL inference pipeline 100 includes a third-party search engine 120, a URL inference service 140, an organization database 130, a search database 132, an aggregator database 134, and a feature database 136.

In one embodiment, URL inference service 140 includes a search component 142, a filtering component 144, a classification component 146 that includes a normalization component 148, a modeling component 150, and a prediction component 152, and a training component 154. Other embodiments may include more or less than these components.

Organization database 130 stores a set of organization identifiers that uniquely identify respective organizations. URL inference service 140 accesses organization database 130 to retrieve or store the organization information, such as a website address (a colloquial term for URL), a phone number, a size, an industry, a product or a service, a location, a founder, or members. If URL inference service 140 does not have a URL of a particular organization's website, URL inference service 140 obtains the URL from third-party search engine 120 and stores the URL information in organization database 130 after verifying that the URL is correct (or likely correct). The organization that is not associated with a URL in organization database 130 can be a candidate for the URL inference model.

A URL is a reference to a web resource that specifies the location of the web resource on a computer network, such as the Internet. A URL (e.g., http://example.com) comprises a protocol identifier (e.g., http) and a resource name (e.g., example.com). The URL of the organization's website can be a web address of the main website, commonly referred to as a “homepage” of the organization. The main website is an official website of the organization (e.g., an organic website) and can serve as a landing page to attract visitors from a search engine.

### Search Component

In order to obtain the organic URL address of the organization, search component 142 sends a search query to third-party search engine 120. Search component 142 can create and send an SQL (Structured Query Language) query to an API (Application Programming Interface) endpoint provided by third-party search engine 120. Alternatively, search component 142 may create an HTTP (Hypertext Transfer Protocol) request that includes one or more query terms and transmits the HTTP request using the IP protocol over one or more networks (e.g., the Internet) to third-party search engine 120. The query includes an organization name (e.g., DEAN MITCHELL CREATIVE LIMITED). In an embodiment, the query also includes a geographic indicator, such as a country code that is specific to a country or a name of a country, province, state, or non-political region. For example, if the organization is a Chinese organization, then the country code specific to China can be part of the query to initiate a country-based search process. Using the country code in the search process can confine the search domain to limit the search space. A geographic-based query may help to differentiate one organization from another organization which shares the same name but located in a different geography or country.

In a related embodiment, the query includes a mailing address of the organization or an e-mail address of a founder or employee to confine the search within a specific area. The query can further include a particular organization domain (e.g., school.go.kr) as a search parameter to limit the search within the organization domain (government schools in Korea) to verify the correct URL of the organization. In a related embodiment, the query search parameter can filter out adult-related content by excluding adult websites that are not related to the organization.

Any third-party search engine (e.g., BING) can be used to perform a search based on a query and returns a set of search results to URL interference service 140. Each search result of the set of search results may include a name of the website (e.g., a page name), a URL, and/or a short summary (e.g., a snippet) of the website. The name of the website herein refers to a page title. In some embodiments, the page title includes a sequence of words that matches the query string. The URL acts as a web address of the website, a location of a specific web page on the Internet. The short summary includes a few sentences containing words that match best against the query string. The search result can be stored in search database 132.

### Filtering Component

Filtering component 144 filters out the known aggregator domains from the search result. An aggregator is a website or a program that collects related electronic content from various sources and displays them in one unified presentation. Example aggregators include LINKEDIN, FACEBOOK, and YELP. The existence of an aggregator's website can hinder determining an organic organization URL. For example, considering URLs of multiple aggregators will slow down URL inference service 140. Also, considering URLs of aggregators increases the chances of identifying a false positive.

In order to identify aggregator domains, for each aggregator, filtering component 144 calculates domain frequency among all queries for organizations. For example, filtering component 144 submits one hundred queries to third-party search engine 120. Each query includes an organization name that is different from one another. For each set of search results from each of the one hundred queries, filtering component 144 generates a count of each domain that is returned as a search result (or number of times each domain is displayed as a search result). In some embodiments, the domain frequency can be determined by calculating a value for Inverse Document Frequency (IDF). The IDF can be calculated using the following equation:

$$idf ( t , D ) = log \frac{N}{\vert \{ d ∈ D : t ∈ d \} \vert}$$

where “N” denotes the total number of documents, “t” denotes a term, “d” denotes a document, and the denominator refers to the number of documents where the term “t” appears.

If the calculated IDF (e.g., IDF=3) is smaller than a threshold IDF (e.g., four in common logarithm), then the domain is classified as an aggregator domain. For example, if a particular domain appears one thousand times for one million different queries, then it is likely that the particular domain is classified as an aggregator domain based on its high domain frequency (IDF=3). In other words, if the particular domain appears in the search result frequently, the likelihood that the particular domain is classified as an aggregator domain is high.

After determining an IDF for each domain, the aggregator domains are collected and stored in aggregator database 134. The stored list of aggregators can be used for future filtering of URLs. For example, after the list of aggregator domains is populated and stored in aggregator database 134, when a new set of search results is received at URL inference service 140 based on a new query, filtering component 144 filters out the known aggregator domains retrieved from aggregator database 134 from the new set of search results, narrowing down the candidate URLs.

### Classification Component

After the filtering process, classification component 146 can classify the URLs by creating and normalizing the data for a prediction model. A classification process can include a normalization process performed by normalization component 148, a modeling process performed by modeling component 150, and a prediction process performed by prediction component 152.

### Normalization Component

Normalization component 148 performs the data preparation and the data normalization. Firstly, normalization component 148 normalizes an organization name or a page name by removing a stop word or a common suffix from the organization name or the page name. A stop word is a generic word that does not provide a specific meaning to the name, such as “the,” “a,” or “an.” A common suffix is a word that represents a type of organization entity, such as “LIMITED” or “LTD.” After the first step of the normalization process, the organization name “Dean Mitchell Creative Limited” is shortened to “Dean Mitchell Creative.”

Secondly, normalization component 148 extracts the domain name from the URL by removing a protocol name (HTTP), a sub-domain name (WWW), or a top-level domain name (CO.UK). After the second step of the normalization process, the domain name (“deanmitchellcreative”) can be extracted from the URL (“https://deanmitchellcreative.co.uk”).

Thirdly, normalization component 148 converts the text of the organization name to lowercase. After the third step of the normalization process, the organization name (“DEAN MITCHELL CREATIVE LIMITED”) is converted to “dean mitchell creative.” It is contemplated that these normalization steps may be performed in any order. An example data structure showing the transformation is shown in table 1 and table 2.

TABLE 1
(raw data)

| Organization | | | |
|---|---|---|---|
| Name | Page Name | Url | Rank |
| DEAN | Dean | https://deanmitchellcreative.co.uk/ | 1 |
| MITCHELL | Mitchell | | |
| CREATIVE | | | |
| LIMITED | | | |

TABLE 2
(after a normalization process)

| Organization Name | Page Name | Domain Name | Rank |
|---|---|---|---|
| Dean Mitchell creative | Dean Mitchell | deanmitchellcreative | 1 |

### Modeling Component

Modeling component 150 calculates a set of feature values that is associated with each search result. When calculating feature values, the normalized data (e.g., domain name, organization name) can be used as a parameter. A non-limiting example set of features can include Jaro distance between an organization name and a domain name, Edit distance between an organization name and a domain name, Jaro distance between an organization name and a page name, Jaccard distance between an organization name and a domain name, the number of words an organization name and a substring of a domain name share, a rank of the URL in the search result, and a URL path depth.

### Feature 1: Jaro Distance Between an Organization Name and a Domain Name

Modeling component 150 calculates a value for a Jaro distance between the organization name and the domain name. Jaro distance is a measure of similarity between the two text strings. The Jaro distance of two strings s₁ and s₂ can be calculated using the following equation:

$${sim}_{j} = \{ \begin{matrix}0 & if m = 0 \\ \frac{1}{3} ( \frac{m}{\vert {s}_{1} \vert} + \frac{m}{\vert {s}_{2} \vert} + \frac{m - ɛ}{m} ) & otherwise\end{matrix}$$

where “m” is the number of matching characters, “t” is half the number of transpositions, “|s₁|” is the length of the string s₁, and “|s₂|” is the length of the string s₂ The number of matching characters divided by two (“2”) defines the number of transpositions. Each character of S₁ is compared with all its matching characters in s₂. The score is normalized such that zero (“0”) equates to no similarity and one (“1”) is an exact match. The higher the value of the Jaro distance for two strings is, the more similar the strings are.

### Feature 2: Edit Distance Between an Organization Name and a Domain Name

Modeling component 150 calculates a value for an Edit distance between the organization name and the domain name. Edit distance is a character-based measure of dissimilarity between two text strings. Edit distance can be calculated by counting the minimum number of operations required to transform one string into another string. For example, if the company name is “AB” and the domain name is “AC,” then the minimum number of operations required to transform one string (“B”) into the other (“C”) would be two, because one operation is needed to delete “B” and another operation is needed to insert “C” (substitution of “C” for “B”). In another example, a total number of operations needed to transform the organization name “dean mitchell” to a domain name “deary mitchell” is three (1. first operation to delete “n” at the fourth letter; 2. second operation to insert “r” at the fourth letter (replacing “r” with “n”); 3. third operation to insert “y” at the fifth letter).

### Feature 3: Jaccard Distance Between an Organization Name and a Page Name

Modeling component 150 calculates a value for a Jaccard distance between the organization name and the page name. Jaccard distance is a word-based measure of dissimilarity between two text strings. Jaccard distance can be calculated by the size of the intersection of the two sets of data divided by the size of the union of the two sets of data. Jaccard distance can be calculated using the following equation:

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} .$$

Using the equation, the numerator can be calculated based on the number of words the organization name (A) and the page name (B) share. In this example, the number of words the organization name (Dean Mitchell Creative) and the page name (Dean Mitchell) shares is two (“dean” and “mitchell”). The denominator can be calculated based on the total number of words the organization name and the page name have. The total number of words the organization name and the page name have is three (“dean,” “mitchell,” and “creative”). Consequently, Jaccard distance value between the organization name and the page name is ⅔ (0.66).

### Feature 4: Jaro Distance Between an Organization Name and a Page Name

Modeling component 150 calculates a value for a Jaro distance between the organization name and the page name (in feature 1, modeling component 150 calculates the Jaro distance between the organization and the domain name). The higher the Jaro distance value is between the organization and the page name, the more similar the organization name and the page name are. The more similar the organization name and the page name are, the more likely the URL of the page refers to the organic website of the organization.

### Feature 5: Number of Words the Organization Name and the Substring of Domain Name Share

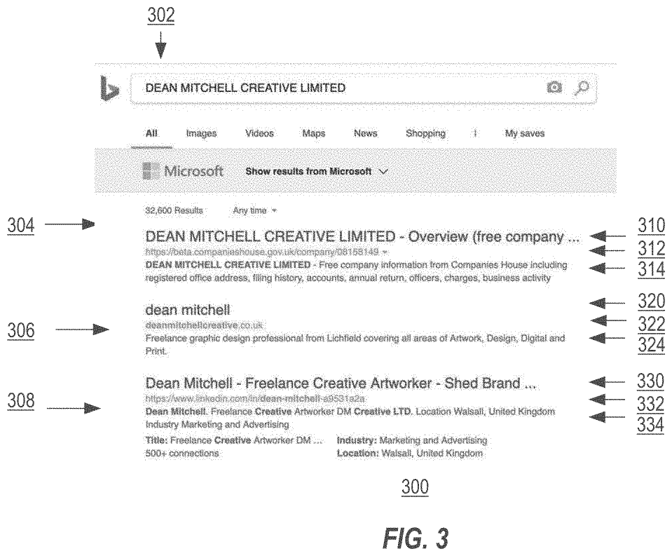

Modeling component 150 calculates the number of words the organization name and the domain name share. For example, the organization name, Dean Mitchell Creative, consists of three words, “dean,” “mitchell,” and “creative.” Modeling component 150 determines how many of these three words appear in the domain name of the search result. For example, for the COMPANIES HOUSE website (https://beta.companieshouse.gov.uk/company/08158149) 304 of FIG. 3, none of these three words appear in the domain name. For the Dean Mitchell website (deanmitchellcreative.co.uk) 306 of FIG. 3, all of three words appear in the domain name. For the LinkedIn website 308 of FIG. 3, two of these words appear in the domain name (https://www.linkedin.com/in/dean-mitchell-a9531a2a). In some embodiments, the two aggregator websites (COMPANIES HOUSE and LinkedIn) might already have been filtered out before calculating the feature values. This example embodiment merely shows how the feature value is calculated. Since the Dean Mitchell website contains the greatest number of words in its domain, the Dean Mitchell website 306 is more likely to be the organic website for the “Dean Mitchell Creative” organization than the other two websites.

### Feature 6: Ranking of the URL in the Search Result

For each URL, modeling component 150 calculates a ranking value. A ranking value is determined based on the location of the URL within the search result. In other words, the ranking value is determined based on a rank of a particular search result relative to other search results in the set of search results. For example, the organic website of Dean Mitchell 306 in FIG. 3 has a ranking value of two because it appeared in second place in the search result 300. The LinkedIn aggregator 308 has a ranking value of three because it appeared in third place in the search result 300. (Alternatively, the ranking may be zero-based, where a zero ranking is the highest ranking. Embodiments are not limited to any particular ranking measure.) If a specific URL is associated with a lower ranking value (appears on the top of the search result), then the specific URL is deemed to be more directly related to the organization name. Consequently, the Dean Mitchell website 306 that is placed in second place in the search result is more likely to be the organic website for the organization than the LinkedIn website 308 that is placed in third place in the search result.

### Feature 7: URL Path Depth

For each URL, modeling component 150 calculates a value for the URL path depth. The URL path depth herein refers to a number of clicks that is needed to reach a specific page from a homepage. In one embodiment, the URL path depth can be calculated based on the count of slashes (“/”) in the URL. The lower the count is, the more likely that the URL is the organic website for the organization. Modeling component 150 determines that the web page is less important of the page in the domain if the path depth is long. For example, the LinkedIn aggregator 308 has a value of three for the URL path depth because the URL (https://www.linkedin.com/in/dean-mitchelle-a9531a21) includes two slashes (“/”). In other words, it might take two clicks to reach the LinkedIn web page 308 from the LinkedIn homepage (www.linkedin.com). In another example, the Dean Mitchell web page 306 has a value of one for the URL path depth because the URL does not include any slashes.

Feature database 136 stores each feature value that is calculated from modeling component 150. The feature values are updated periodically when the search result is received at URL interference service 140. The feature values can be used to examine the relationships between two or more features to determine a more predictive and determinative feature in determining the organic website URL.

### Training Component

A machine learning technique determines which of these features (e.g., variables) are more important than the other features when determining the weight value for the more important features. The more important features have higher weights (i.e., coefficients) than less important features. For example, Jaro distance between the organization name and the domain name feature (feature 1) may be assigned a higher weight than the URL path depth feature (feature 7) if it is determined that the Jaro distance between the organization name and the domain name is a more determinative feature than the URL path depth feature when predicting the organic website URL.

One or more machine learning techniques are used to train a prediction model to predict URLs (e.g., homepage) of the organizations. Non-limiting examples of machine learning techniques to train a prediction model include Linear Regression (LR), Support Vector Machines (SVMs), Random Forest (RF), and Artificial Neural Networks (ANNs). The machine learning techniques can train the prediction model using a set of training data. In some embodiments, labels (such as a “true” or a “false”) can be assigned to the training data to indicate whether a URL of the search result is indeed the correct organic URL of the organization. In some embodiments, human labor is required to manually verify and tag the label to the training data. In an embodiment, negative samples are generated automatically where, for each negative sample, a “true” URL is known for a particular organization and a different URL is extracted from a set of search results based on an organization name of the particular organization. The different URL and the organization name are used as a negative sample.

Based on the training data and associated labels, a prediction model can be trained using one or more machine learning techniques. If multiple prediction models are trained based on different machine learning techniques, then, based on the precision and recall statistics representing the accuracy of each machine learning technique, training component 154 selects the most accurate prediction model.

### Prediction Component

After training component 154 trains the prediction model using one or more machine learning techniques, the trained prediction model can be used to generate a prediction on new data (a new set of search results based on a new search query that is submitted after the training process). After receiving the set of search results and identifying the set of feature values associated with the corresponding search result, prediction component 152 can input the set of feature values to the prediction model to generate a prediction. In some embodiments, the machine-learned prediction model generates a score for each candidate URL based on the feature values.

Based on the prediction, prediction component 152 determines whether to associate the URL of the search result with the organization name. In some cases, the scores of multiple search results based on an organization name are above a threshold. In those cases, the search result with the highest score is used to associate the corresponding URL with the organization name. The association information can be stored in organization database 130. In some cases, the score of each search result is below a threshold. In those cases, it may be determined that none of the search results includes a correct URL of the organization and the association will not be made.

### Process Overview

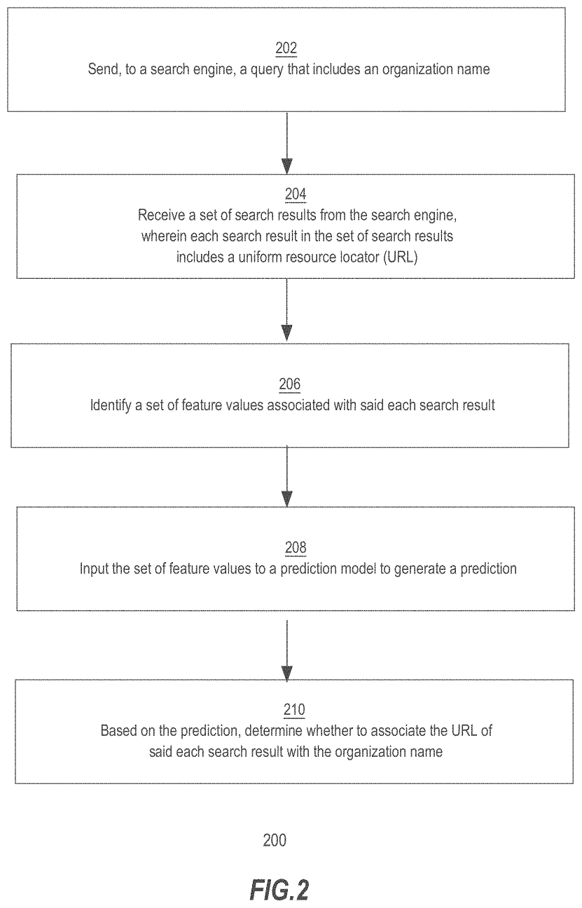

FIG. 2 is a flow diagram that depicts a process for inferring an organic website URL of an organization based on a web search result, in an embodiment. Process 200 may be implemented by URL inference service 140.

At block 202, URL inference service 140 sends a search query to third-party search engine 120. FIG. 3 is an example graphical user interface of the search result 300 including a search query 302 (e.g., Dean Mitchell Creative Limited), in an embodiment. In a related embodiment, the query includes a country code specific to a particular country. Third-party search engine 120 may provide an API that allows a user to specify a query parameter to confine the search within a particular domain, a particular country, or particular content. At block 204, as a result of the search query, URL inference service 140 receives a set of search results 304, 306, 308 from third-party search engine 120. Each search result includes one or more fields including a respective name of the website 310, 320, 330, a respective URL 312, 322, 332, and a respective short summary 314, 324, 334 extracted from the corresponding website.

A search result might correspond to one of the multiple different types of websites, such as an organic website, an aggregator website, or a forum website. An organic website is an official website of an organization. In FIG. 3, example aggregator domains are “COMPANYHOUSE.GOV.UK” 304 and “LINKEDIN.COM” 308, and the organic domain is “DEANMITCHELLCREATIVE.CO.UK” 306. Aggregator database 134 can be updated when a new search result is received from the search engine. The known aggregator stored in aggregator database 134 can be used to filter out the aggregator domains from the search result for a later query. For example, based on the known aggregator domain, one or more search results 304, 308 can be filtered out, and removed from the candidate pool.

In some embodiments, the set of search results is normalized to calculate the feature values. Transforming the data may comprise removing redundant or unnecessary text strings, such as a common suffix or a stop word, from the organization name, the page name, or the domain name. For an efficient comparison of the data set that is used to calculate the feature values, the input data is simplified to only contain the important text.

At block 206, for each search result in the set of search results, URL inference service 140 identifies a set of feature values with each search result. A non-exclusive example set of features can include Jaro distance between the organization name and the domain name, Edit distance between the organization name and the domain name, Jaro distance between the organization name and the page name, Jaccard distance between the organization name and the domain name, the number of words the organization name and the substring of the domain name share, rank of the URL in the search result, and the URL path depth.

In some embodiments, some features calculate a measure of similarity between two text strings that includes an organization name, a page name, or a domain name. Other features calculate the URL path depth and the ranking of the URL in the search result. The rank of the search result is determined relative to other search results in the set of search results. The URL path depth can be determined based on a number of paths in the URL of each search result. The feature values are calculated to determine the best match against the query string (organization name). The feature values are calculated using the normalized data and the calculated values for each feature can be stored in feature database 136.

At block 208, URL inference service 140 inputs the set of feature values to a machine-learned prediction model to generate a prediction. The machine-learned prediction model generates a score for each candidate URL based on the feature values and the corresponding weights for the feature values. The corresponding weights for each feature value may be determined based on the existing training data.

At block 210, based on the prediction, a determination whether to associate a candidate URL of each search result with the organization name is made. In other words, an organic website URL for the organization might be determined. For example, Dean Mitchell website 306 can be determined to be an organic website URL for the organization, Dean Mitchell Creative Limited, after running the prediction model. Once the search result 306 is determined to be the organic website URL, the association with the organization name and the URL is stored in organization database 130. In some cases, it may be determined that none of the search results based on an organization includes a correct URL of the organization. In other words, the score of each search result is below a threshold.

In some cases, the scores of multiple search results based on an organization name are above a threshold. In those cases, the search result with the highest score is used to associate the corresponding URL with the organization name. Alternatively, the URL of each search result with a score above the threshold is stored in association with the organization name and a human reviewer is notified of the situation and can manually verify which of the candidate URLs is the correct URL, if any.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

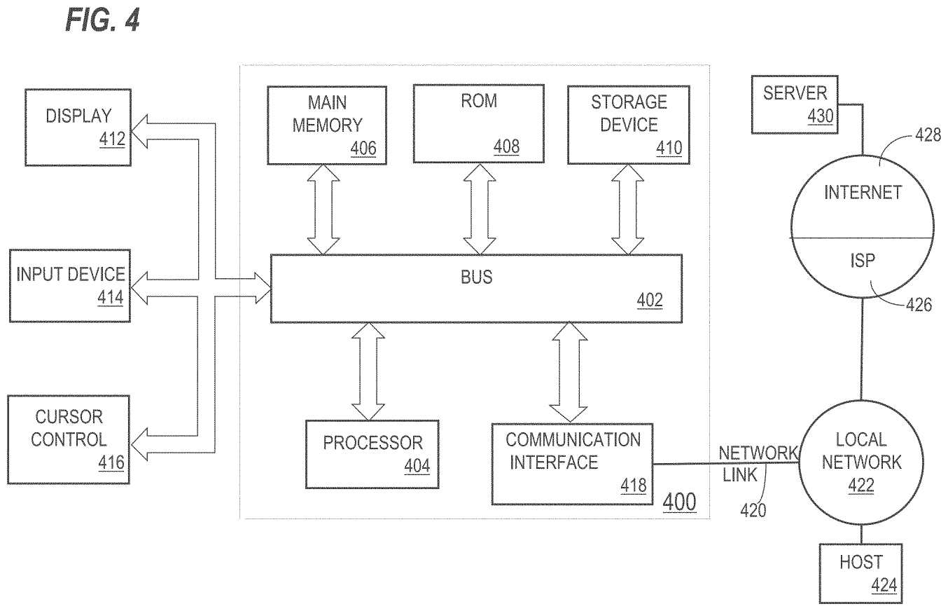

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

A cache is included as part of the main memory 406/storage components. The cache may be implemented using any conventional, sufficiently fast technology, such as by using one or more flash memory devices, random access memory, a portion of main memory, etc. The cache may be implemented as a Solid-State Disk (SSD) or a as a module on the server. Cache memory is read and written to store the HTML content generated at URL inference service 140.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
sending, to a search engine, a query that includes an organization name;
as a result of the query, receiving a set of search results from the search engine, wherein each search result in the set of search results includes a uniform resource locator (URL);
for each search result in the set of search results:
identifying a set of feature values associated with said each search result;
inputting the set of feature values to a prediction model to generate a prediction; and
based on the prediction, determining whether to associate the URL of said each search result with the organization name;
wherein the method is performed by one or more computing devices.

2. The method of claim 1, wherein the set of feature values associated with said each search result includes a rank of said each search result relative to other search results in the set of search results.

3. The method of claim 1, wherein the set of feature values associated with said each search result includes a number of paths in the URL of said each search result.

4. The method of claim 1, wherein the set of feature values associated with said each search result includes a measure of similarity between the organization name and a name of a page of said each search result.

5. The method of claim 4, wherein the measure of similarity is one of a Jaro distance or a Jaccard distance.

6. The method of claim 1, wherein the set of feature values associated with said each search result includes a measure of similarity between the organization name and a name of a domain of said each search result.

7. The method of claim 6, wherein the measure of similarity is one of a Jaro distance or an edit distance.

8. The method of claim 1, before sending the query to the search engine, further comprising:
sending a plurality of queries to the search engine, each query includes an organization name different from one another;
as a result of the plurality of queries, receiving sets of search results, each set including a URL corresponding to a respective query;
for each search result in the sets of the search results, calculating an inverse document frequency representing a rate at which a domain of the URL occurs in the sets of the search results;
comparing the inverse document frequency of each search result to a threshold frequency;
upon determining that the inverse document frequency is smaller than the threshold frequency, identifying the search result as an aggregator domain;
storing the aggregator domain as a known aggregator domain in an aggregator database.

9. The method of claim 8, before identifying the set of feature values, further comprising:
retrieving the known aggregator domain that is stored in the aggregator database;
filtering out the known aggregator domain from the set of search results.

10. The method of claim 1, further comprising:
generating training data that comprises a plurality of training instances, each of which comprises a label and a plurality of feature values for a plurality of features of a search result generated as a result of a particular organization name; and
using one or more machine learning techniques to train the prediction model based on the training data, wherein the prediction model includes a set of weights for the plurality of features and is used to predict whether to associate a particular URL of a subsequent search result with a certain organization name that was used to generate the subsequent search result.

11. The method of claim 1, wherein the query includes a parameter that represents a country that is associated with the organization.

12. One or more storage media storing instructions which, when executed by one or more processors, cause:
sending, to a search engine, a query that includes an organization name;
as a result of the query, receiving a set of search results from the search engine, wherein each search result in the set of search results includes a uniform resource locator (URL);
for each search result in the set of search results:
identifying a set of feature values associated with said each search result;
inputting the set of feature values to a prediction model to generate a prediction; and
based on the prediction, determining whether to associate the URL of said each search result with the organization name.

13. The one or more storage media of claim 12, wherein the set of feature values associated with said each search result includes a rank of said each search result relative to other search results in the set of search results.

14. The one or more storage media of claim 12, wherein the set of feature values associated with said each search result includes a number of paths in the URL of said each search result.

15. The one or more storage media of claim 12, wherein the set of feature values associated with said each search result includes a measure of similarity between the organization name and a name of a page of said each search result.

16. The one or more storage media of claim 15, wherein the measure of similarity is one of a Jaro distance or a Jaccard distance.

17. The one or more storage media of claim 12, wherein the set of feature values associated with said each search result includes a measure of similarity between the organization name and a name of a domain of said each search result.

18. The one or more storage media of claim 17, wherein the measure of similarity is one of a Jaro distance or an edit distance.

19. The one or more storage media of claim 12, wherein the instructions, when executed by the one or more processors, further cause, before sending the query to the search engine:
sending a plurality of queries to the search engine, each query includes an organization name different from one another;
as a result of the plurality of queries, receiving sets of search results, each set including a URL corresponding to a respective query;
for each search result in the sets of the search results, calculating an inverse document frequency representing a rate at which a domain of the URL occurs in the sets of the search results;
comparing the inverse document frequency of each search result to a threshold frequency;
upon determining that the inverse document frequency is smaller than the threshold frequency, identifying the search result as an aggregator domain;
storing the aggregator domain as a known aggregator domain in an aggregator database.

20. The one or more storage media of claim 19, wherein the instructions, when executed by the one or more processors, further cause, before identifying the set of feature values:
retrieving the known aggregator domain that is stored in the aggregator database;
filtering out the known aggregator domain from the set of search results.
